(19) United States
(12) Patent Application Publication
(10) Pub. No.: US 2012/0057743 A1
(43) Pub. Date: Mar. 8, 2012

(54) System and method for fluorescence guided ingredient specific particle sizing

(75) Inventors: Ryan Priore, Wexford, PA (US); Oksana Olkhovyk, Pittsburgh, PA (US); Michael Fuhrman, Pittsburgh, PA (US)

(73) Assignee: ChemImage Corporation, Pittsburgh, PA (US)

(21) Appl. No.: 13/317,333

(22) Filed: Oct. 14, 2011

Related U.S. Application Data
(63) Continuation-in-part of application No. 12/684,495, filed on Jan. 8, 2010.
(60) Provisional application No. 61/455,149, filed on Oct. 15, 2010.
(60) Provisional application No. 61/143,562, filed on Jan. 9, 2009.

(51) Int. Cl. G06K 9/00

(52) U.S. Cl. 382/100

(57) ABSTRACT

The present disclosure provides for a system and method for rapid, accurate, and reliable targeting and interrogation of pharmaceutical samples. An autofluorescence image of a sample may be generated and analyzed to identify areas of interest that exhibit autofluorescence characteristic of APIs. These areas of interest may then be targeted for analysis using Raman chemical imaging. This Raman chemical image may be used to determine geometric properties of particles present in a sample such as size and particle distribution.

### RELATED APPLICATIONS

This application claims priority under 35 U.S.C. §119(e) to pending U.S. Provisional Patent Application No. 61/455,149, filed on Oct. 15, 2010, entitled “Fluorescence Guided Ingredient-Specific Particle Sizing Of Nasal Suspension Formulations.” This application is also a continuation-in-part of pending U.S. patent application Ser. No. 12/684,495, filed on Jan. 8, 2010, entitled “Automation of Ingredient-Specific Particle Sizing Employing Raman Chemical Imaging,” which itself claims priority to U.S. Provisional Patent Application No. 61/143,562, filed on Jan. 9, 2009, entitled “Automation of Ingredient-Specific Particle Sizing Employing Raman Chemical Imaging.” Each of the above-referenced patents and patent applications are hereby incorporated by reference in their entireties.

### BACKGROUND

Surfaces form the interface between different physical and chemical entities, and the physical and chemical processes that occur at surfaces often control the bulk behavior of materials. For example, the rate of dissolution of drug particles in a biological fluid (e.g., stomach, intestinal, bronchial, or alveolar fluid in a human) can strongly influence the rate of uptake of the drug into an animal. Differences in particle size distribution between two otherwise identical compositions of the same drug can lead to significant differences in the pharmacological properties of the two compositions. Further by way of example, the surface area of a solid chemical catalyst can strongly influence the number and density of sites available for catalyzing a chemical reaction, greatly influencing the properties of the catalyst during the reaction. For these and other reasons, manufacturers often try to closely control particle size and shape. Associations between and among particles can also affect the pharmacological properties of substances in the particles, such as the ability of a substance to dissolve or become active in a biological system.

Numerous methods of analyzing particle sizes and distributions of particle sizes are known in the art, including at least optical and electron microscopy, laser diffraction, physical size exclusion, dynamic light scattering, polarized light scattering, mass spectrometric, sedimentation, focused beam backscattered light reflectance, impedance, radiofrequency migration, Doppler scattering, and other analytical techniques. Each of these techniques has a variety of limitations that preclude its use in certain situations.

In addition to distinguishing particles based on chemical composition, it is also useful to determine particle size and particle size distribution (PSD). Particle sizing of Active Pharmaceutical Ingredients (APIs) and Excipients of Interest (EIs) implemented using image analysis must be accurate because of the requirements of customers and the Food and Drug Administration (FDA). The FDA acknowledges a critical path opportunity for the development of methodologies for accurate and precise drug particle size measurements in suspension products, thereby minimizing the requirement for in vivo testing.

Batch comparison testing is an important part of product quality studies and is necessary in studying bioavailability (BA) and/or establishing bioequivalence (BE) for products including, but not limited to, nasal sprays. It is recommended by the FDA that in the BA and BE submission that PSD data is submitted for both new drugs (NDAs) and abbreviated new drug applications (ANDAs) for spray and aerosol formulations. Data must be presented prior to and post actuation since this information closely relates to the drug efficacy based on the dissolution rate of the particles. Such information can help establish the potential influence of the device on de-agglomeration.

Optical microscopy is currently the recommended method of assessing and reporting drug and aggregated drug PSD. However, such methodology is subjective and cannot be used with a high degree of confidence for formulated suspensions where drug particle sizing can be easily misjudged due to the presence of insoluble excipients.

Inhaled drug bioavailability and efficacy closely correlate with the particle size of the API. Formation of polymorphs, drug degradation or excessive agglomeration of the drug-to-drug or drug-to-excipient particles can severely perturb bioavailability of the API and affect the stability of the final formulation. The FDA recommends using optical microscopy to report drug and aggregated drug particle size distribution (PSD) as well as the extent of agglomeration in the Draft Guidance for Industry. Nasal spray suspensions are typically dried onto a substrate or filtered through a membrane filter before microscopy analysis resulting in a cluttered environment for optical imaging. Nasal spray suspensions intended for a spectroscopy confirmation step typically include a drying process post sample actuation. API particles may become embedded into the matrix and missed by optical microscopy techniques relying on refractive index differences for image contrast; new respiratory therapeutics include combination drugs that contain more than one API which may appear similar under the microscope. Optical microscopy alone lacks the specificity for API particle identification and relies on particle class differentiation based on morphology even as a targeting mechanism for spectroscopy confirmation.

Correct identification of drug particles based on chemistry is essential for the development of better formulations, since the changes in chemical structure of API(s) can affect pharmacological properties of the final product. There exists a need for accurate and reliable systems and methods for the identification and sizing of particles.

Spectroscopic imaging combines digital imaging and molecular spectroscopy techniques, which can include Raman scattering, fluorescence, photoluminescence, ultraviolet, visible, short wave infrared (SWIR), and infrared absorption spectroscopies. When applied to the chemical analysis of materials, spectroscopic imaging is commonly referred to as chemical imaging. Chemical imaging is a reagentless tissue imaging approach based on the interaction of laser light with tissue samples. The approach yields an image of a sample wherein each pixel of the image is the spectrum of the sample at the corresponding location. The spectrum carries information about the local chemical environment of the sample at each location. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over an entire area encompassing the sample simultaneously using an electronically tunable optical imaging filter such as an acousto-optic tunable filter (AOTF), a multi-conjugate tunable filter (MCF), or a liquid crystal tunable filter (LCTF). Here, the organic material in such optical filters are actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

One method for using Raman spectroscopic methods for component particle analysis is described in U.S. Pat. No. 7,379,179 to Nelson et al., entitled “Raman Spectroscopic Methods for Component Particle Analysis”, which is hereby incorporated by reference in its entirety.

By providing a “molecular fingerprint”, Raman spectroscopy has become one of the most powerful analytical tools to study molecular composition, identify polymorphs and pseudopolymorphs and evaluate other physico-chemical properties of micron-sized particles. Ultimately, Raman spectroscopy may provide the basis for predicting and controlling future drug properties. New approaches to ingredient specific particle sizing (ISPS) include Wide-field Raman Chemical Imaging (RCI) or optical microscopy followed by Raman microspectroscopy. Recent advancements such as automatic data collection, imaging data processing and particle size distribution (PSD) generation allow an unsupervised ISPS analysis of a statistically significant population of API particles across all Orally Inhaled and Nasal Drug Products (OINDP).

Because OINDP samples contain sparse particle populations, optical microscopy has been leveraged for rapid particle targeting where the identified particles are further interrogated using Raman spectroscopy for chemical identification. In the marketplace, optical microscopy alone has been demonstrated to classify API particles of OINDP samples on the basis of morphological features for further interrogation; however, the method relies on morphologically unique particles in the sample. This method has been shown to work well for foreign particulate matter measurements, but this may not necessarily be ideal for nasal spray suspensions.

No validated method exists for characterizing the ingredient-specific drug particle size in complex nasal spray suspensions due to the presence of insoluble excipients along with suspended API in the formulation. Accurate knowledge of the API particle size is critical for determining the ultimate dissolution rate in the mucous membrane of the nasal cavity as well as establishing bioequivalence (sameness) between a generic and innovator products. Current methods used for such measurements include Anderson Cascade Impaction (ACI) followed by High Performance Liquid Chromatography (HPLC), laser light scattering and optical microscopy; however, each method lacks the ability to perform ingredient specific particle sizing (ISPS).

There exists a need for a rapid, accurate, and reliable system and method of interrogating pharmaceutical samples. It would also be advantageous to devise a rapid screening methodology to target areas of a sample likely to contain APIs. This would significantly reduce the time required for data acquisition by eliminating the need to interrogate the entire sample.

### SUMMARY OF THE INVENTION

The present disclosure relates generally to a system and method for ingredient specific particle sizing. More specifically, the invention disclosed herein provides for fluorescence-guided ingredient specific particle sizing. An ideal imaging-based, ISPS process for nasal spray suspensions may include a rapid, semi-selective targeting measurement followed by a confirmation measurement with high chemical specificity. The ISPS analysis may be performed after returning to specific regions of interest (ROI) based upon the targeting process. Methodologies including brightfield reflectance, cross-polarization and autofluorescence may be investigated as targeting mechanisms for identifying ROIs containing the API of a nasal spray formulation for a wide-field RCI process.

A sample may be divided into a plurality of regions (using a grid or similar format) for mapping locations in the sample. An autofluorescence image of a sample may be generated. Because active ingredients of interest will autofluoresce and non-active ingredients will not, this autofluorescence image holds potential for indicating areas of a sample where there is a high probability of locating active ingredients of interest. These areas of interest can then be targeted for Raman chemical analysis. This Raman chemical analysis can then be used to ascertain information about the particles present in the sample, including geometric information such as particle size and/or distribution. RCI yields spatially accurate spectroscopic information and is well suited for ISPS of complex mixtures.

The present disclosure overcomes the limitations of the prior art by incorporating a pre-screening process for determining the optimal regions for sampling. Such an invention combines the benefit of rapid data analysis associated with autofluorescence with the material specific benefits of Raman chemical analysis. The system and method disclosed herein therefore hold potential for rapid, accurate, and reliable interrogation of samples that may be used to assess particle size and/or distribution of pharmaceutical samples.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

FIG. 1A is a schematic representation of a system of the present disclosure.

FIG. 1B is representative of a method of the present disclosure.

FIG. 2A is illustrative of BFR and PLM images.

FIG. 2B is illustrative of Raman dispersive spectra of various components.

FIG. 3 is representative of particle size distribution for budensonide.

FIGS. 4A-4E is illustrative of the detection capabilities of the system and method of the present disclosure.

FIGS. 5A-5D are illustrative if images of a sample using various modalities.

FIGS. 6A-6D are illustrative of images of a region of interest of the sample in FIGS. 5A-5D using various modalities.

FIGS. 7A-7E are representative Receiver Operator Characteristic (ROC) curves for a region of interest of a sample.

FIGS. 8A-8E are representative ROC curves for a region of interest of a sample.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

The patent or application file contains at least one drawing executed in color. Copies of this patent or patent application publication with color drawing(s) will be provided by the Office upon request and payment of the necessary fee.

The present disclosure provides for a system and method for fluorescence guided ingredient specific particle sizing. The invention disclosed herein holds potential for providing faster and more reliable interrogation of samples, including pharmaceutical samples.

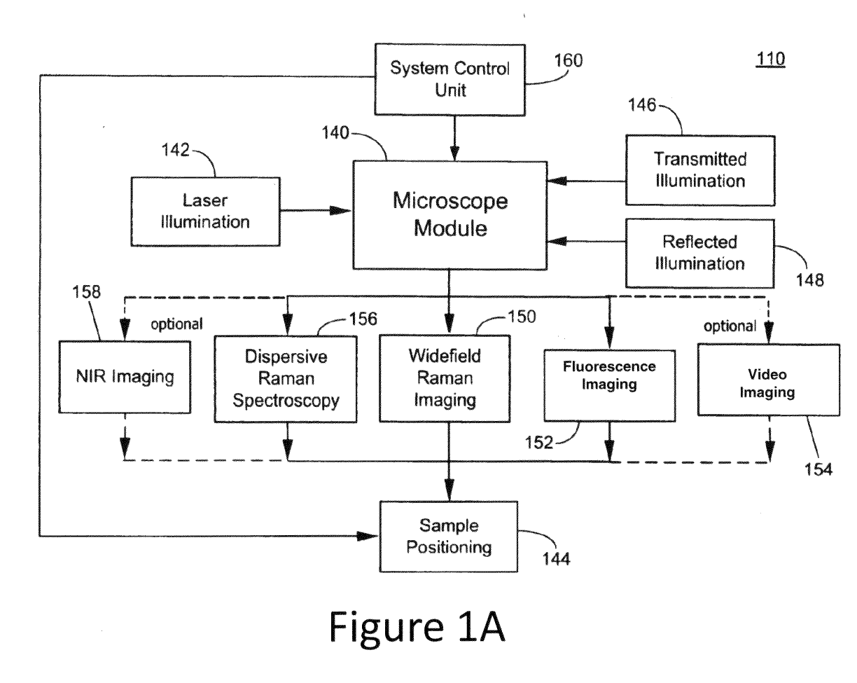

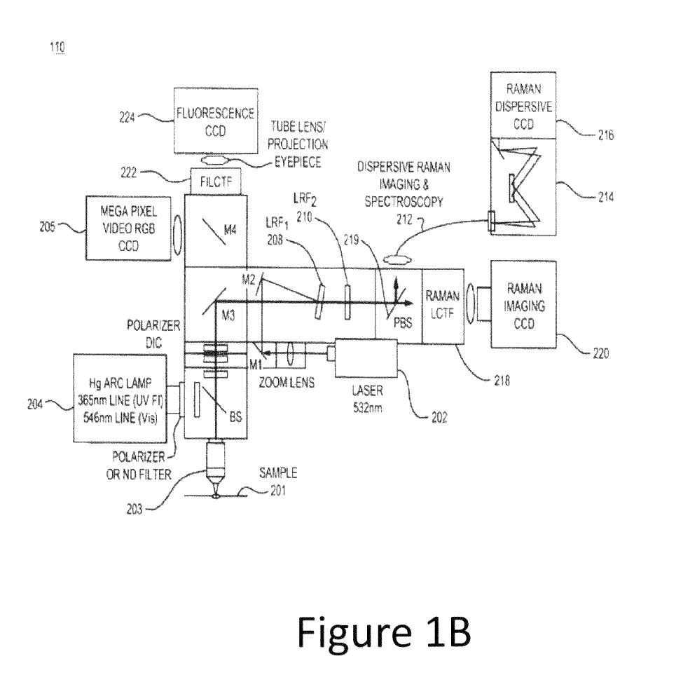

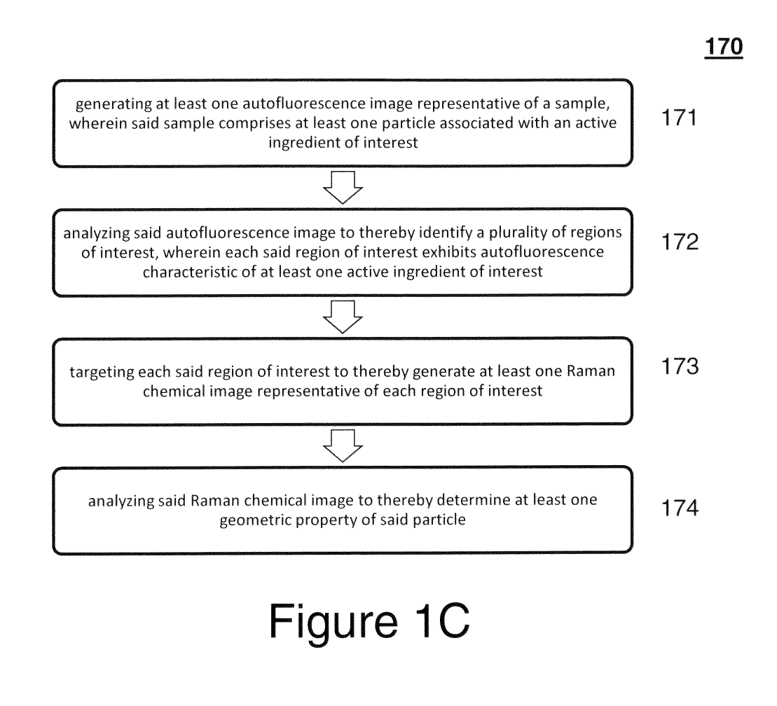

FIG. 1 is illustrative of a system of the present disclosure. The layout in FIG. 1A may relate to a chemical imaging system marketed by ChemImage Corporation of Pittsburgh, Pa. In one embodiment, the spectroscopy module 110 may include a microscope module 140 containing optics for microscope applications. An illumination source 142 (e.g., a laser illumination source) may provide illuminating photons to a sample (not shown) handled by a sample positioning unit 144 via the microscope module 140. In one embodiment, photons transmitted, reflected, emitted, or scattered from the illuminated sample (not shown) may pass through the microscope module (as illustrated by exemplary blocks 146, 148 in FIG. 1) before being directed to one or more of spectroscopy or imaging optics in the spectroscopy module 110. The system of FIG. 1 may be configured so as to generate at least one test Raman data set representative of a sample under analysis. In the embodiment of FIG. 1, dispersive Raman spectroscopy 156, widefield Raman imaging 150 and fluorescence imaging 152 are illustrated as standard. In other embodiments, the modes of NIR imaging 158 and video imaging 154 may also be implemented.

The spectroscopy module 110 may also include a control unit 160 to control operational aspects (e.g., focusing, sample placement, laser beam transmission, etc.) of various system components including, for example, the microscope module 140 and the sample positioning unit 144 as illustrated in FIG. 1. In one embodiment, operation of various components (including the control unit 160) in the spectroscopy module 110 may be fully automated or partially automated, under user control.

It is noted here that in the discussion herein the terms “illumination,” “illuminating,” “irradiation,” and “excitation” are used interchangeably as can be evident from the context. For example, the terms “illumination source,” “light source,” and “excitation source” are used interchangeably. Similarly, the terms “illuminating photons” and “excitation photons” are also used interchangeably. Furthermore, although the discussion hereinbelow focuses more on Raman spectroscopy and imaging, various methodologies discussed herein may be adapted to be used in conjunction with other types of spectroscopy applications as can be evident to one skilled in the art based on the discussion provided herein.

FIG. 1B illustrates exemplary details of the spectroscopy module 110 in FIG. 1 according to one embodiment of the present disclosure. Spectroscopy module 110 may operate in several experimental modes of operation including bright field reflectance and transmission imaging, polarized light imaging, differential interference contrast (DIC) imaging, UV induced autofluorescence imaging, NIR imaging, wide field illumination whole field Raman spectroscopy, wide field spectral fluorescence imaging, wide field visible imaging, wide field SWIR imaging, wide field visible imaging, and wide field spectral Raman imaging. Module 110 may include collection optics 203, light sources 202 and 204, and a plurality of spectral information processing devices including, for example: a tunable fluorescence filter 222, a tunable Raman filter 218, a dispersive spectrometer 214, a plurality of detectors including a fluorescence detector 224, and Raman detectors 216 and 220, a fiber array spectral translator (“FAST”) device 212, filters 208 and 210, and a polarized beam splitter (PBS) 219.

In one embodiment, at least one light source 202 and 204 may comprise a tunable light source. In another embodiment, at least one light source 202 and 204 may comprise a mercury arc lamp. In yet another embodiment, at least one light source 202 and 204 may comprise a monochromatic light source.

At least one Raman detector 216 and 220 may be configured so as to generate at least one test Raman data set representative of a sample under analysis. This test data set may comprise at least one of: a Raman chemical image, a Raman hyperspectral image, a Raman spectrum, and combinations thereof. In one embodiment, at least one Raman detector may comprise a detector selected from the group consisting of: a CCD, an ICCD, a CMOS detector, and combinations thereof. A Raman detector, in one embodiment, may comprise a focal plane array detector.

In one embodiment, a tunable filter may be selected from the group consisting of: a Fabry Perot angle tuned filter, an acousto-optic tunable filter, a liquid crystal tunable filter, a Lyot filter, an Evans split element liquid crystal tunable filter, a Solc liquid crystal tunable filter, a spectral diversity filter, a photonic crystal filter, a fixed wavelength Fabry Perot tunable filter, an air-tuned Fabry Perot tunable filter, a mechanically-tuned Fabry Perot tunable filter, a liquid crystal Fabry Perot tunable filter, and a multi-conjugate tunable filter, and combinations thereof.

In one embodiment, a system of the present disclosure may comprise filter technology available from ChemImage Corporation, Pittsburgh, Pa. This technology is more fully described in the following U.S. patents and patent applications: U.S. Pat. No. 6,992,809, filed on Jan. 31, 2006, entitled “Multi-Conjugate Liquid Crystal Tunable Filter,” U.S. Pat. No. 7,362,489, filed on Apr. 22, 2008; entitled “Multi-Conjugate Liquid Crystal Tunable Filter,” Ser. No. 13/066,428, filed on Apr. 14, 2011, entitled “Short wave infrared multi-conjugate liquid crystal tunable filter.” These patents and patent applications are hereby incorporated by reference in their entireties.

In one embodiment, a FAST device may be used in conjunction with Raman chemical imaging to detect and/or identify particles associated with active ingredients of interest. A FAST device may comprise a two-dimensional array of optical fibers drawn into a one-dimensional fiber stack so as to effectively convert a two-dimensional field of view into a curvilinear field of view, and wherein said two-dimensional array of optical fibers is configured to receive said photons and transfer said photons out of said fiber array spectral translator device and to at least one of: a spectrometer, a filter, a detector, and combinations thereof.

The FAST device can provide faster real-time analysis for rapid detection, classification, identification, and visualization of, for example, particles in pharmaceutical formulations. FAST technology can acquire a few to thousands of full spectral range, spatially resolved spectra simultaneously, This may be done by focusing a spectroscopic image onto a two-dimensional array of optical fibers that are drawn into a one-dimensional distal array with, for example, serpentine ordering. The one-dimensional fiber stack may be coupled to an imaging spectrometer, a detector, a filter, and combinations thereof. Software may be used to extract the spectral/spatial information that is embedded in a single CCD image frame.

One of the fundamental advantages of this method over other spectroscopic methods is speed of analysis. A complete spectroscopic imaging data set can be acquired in the amount of time it takes to generate a single spectrum from a given material. FAST can be implemented with multiple detectors. Color-coded FAST spectroscopic images can be superimposed on other high-spatial resolution gray-scale images to provide significant insight into the morphology and chemistry of the sample.

The FAST system allows for massively parallel acquisition of full-spectral images. A FAST fiber bundle may feed optical information from is two-dimensional non-linear imaging end (which can be in any non-linear configuration, e.g., circular, square, rectangular, etc.) to its one-dimensional linear distal end. The distal end feeds the optical information into associated detector rows. The detector may be a CCD detector having a fixed number of rows with each row having a predetermined number of pixels. For example, in a 1024-width square detector, there will be 1024 pixels (related to, for example, 1024 spectral wavelengths) per each of the 1024 rows.

The construction of the FAST array requires knowledge of the position of each fiber at both the imaging end and the distal end of the array. Each fiber collects light from a fixed position in the two-dimensional array (imaging end) and transmits this light onto a fixed position on the detector (through that fiber's distal end).

Each fiber may span more than one detector row, allowing higher resolution than one pixel per fiber in the reconstructed image. In fact, this super-resolution, combined with interpolation between fiber pixels (i.e., pixels in the detector associated with the respective fiber), achieves much higher spatial resolution than is otherwise possible. Thus, spatial calibration may involve not only the knowledge of fiber geometry (i.e., fiber correspondence) at the imaging end and the distal end, but also the knowledge of which detector rows are associated with a given fiber.

In one embodiment, a system of the present disclosure may comprise FAST technology available from ChemImage Corporation, Pittsburgh, Pa. This technology is more fully described in the following U.S. patents, hereby incorporated by reference in their entireties: U.S. Pat. No. 7,764,371, filed on Feb. 15, 2007, entitled “System And Method For Super Resolution Of A Sample In A Fiber Array Spectral Translator System”; 7,440,096, filed on Mar. 3, 2006, entitled “Method And Apparatus For Compact Spectrometer For Fiber Array Spectral Translator”; 7,474,395, filed on Feb. 13, 2007, entitled “System And Method For Image Reconstruction In A Fiber Array Spectral Translator System”; and 7,480,033, filed on Feb. 9, 2006, entitled “System And Method For The Deposition, Detection And Identification Of Threat Agents Using A Fiber Array Spectral Translator”.

In one embodiment, a processor may be operatively coupled to light sources 202 and 204, and the plurality of spectral information processing devices 214, 218 and 222. In another embodiment, a processor, when suitably programmed, can configure various functional parts of a system and may also control their operation at run time. The processor, when suitably programmed, may also facilitate various remote data transfer and analysis operations. Module 110 may optionally include a video camera 205 for video imaging applications. Although not shown, spectroscopy module 110 may include many additional optical and electrical components to carry out various spectroscopy and imaging applications supported thereby.

A sample 201 may be placed at a focusing location (e.g., by using the sample positioning unit 144 in FIG. 1) to receive illuminating photons and to also provide reflected, emitted, scattered, or transmitted photons from the sample 201 to the collection optics 203. In one embodiment, the sample 201 may include at least one particle associated with at least one active ingredient of interest. The present disclosure contemplates that the system and method disclosed herein may be applied to interrogating samples comprising one active ingredient of interest. In another embodiment, the present disclosure contemplates the system and method disclosed herein may be applied to interrogating samples comprising particles associated with two or more types of ingredients of interest.

In one embodiment, a system of the present disclosure may further comprise a reference database comprising at least one reference data set. In such an embodiment, each reference data set in said reference database may be associated with a known API, a non-API, and combinations thereof. In one embodiment, at least one reference data set may comprise at least one of: a reference hyperspectral Raman image, a reference Raman spectrum, a reference Raman chemical image, and combinations thereof. In one embodiment, said reference data set may comprise a plurality of reference Raman spectra obtained from one or more regions of interest of a known sample.

In one embodiment, a system of the present disclosure may comprise a processor configured so as to execute machine readable program code so as to compare said test Raman data set to at least one of said reference data sets to thereby determine at least one of: a geometric property of at least one particle in said sample, the identity of at least one particle in said sample, and combinations thereof. In one embodiment, a storage medium containing machine readable program code, which, when executed by a processor, may cause said processor to perform the following: generate at least one autofluorescence image representative of a sample, wherein said sample comprises at least one particle associated with an active ingredient of interest; analyze said autofluorescence image to thereby identify a plurality of regions of interest, wherein each said region of interest exhibits autofluorescence characteristic of at least one active ingredient of interest; target each said region of interest to thereby generate at least one Raman chemical image representative of each region of interest; and analyze said Raman chemical image to thereby determine at least one geometric property of said particle. In one embodiment, the storage medium, when executed by a processor, may further cause said processor to apply a particle-specific threshold to said autofluorescence image. In one embodiment, the storage medium, when executed by a processor, may further cause said processor to apply at least one chemometric technique to said Raman chemical image.

FIG. 1C is representative of a method of the present discourse. In one embodiment, the method 170 may comprise generating at least one autofluorescence image representative of a sample in step 171, wherein said samples comprises at least one particle associated with an active ingredient of interest. In one embodiment, the sample may comprise at least two particles, a first particle associated with a first active ingredient of interest and a second particle associated with a second active ingredient of interest. In such an embodiment, the method 170 may further comprise determining at least one geometric property of said first particle and at least one geometric property of said second particle.

In step 172 an autofluorescence image may be analyzed to thereby identify a plurality of regions of interest, wherein each said region of interest exhibits autofluorescence characteristic of at least one active ingredient of interest. In one embodiment, this analyzing may comprise applying a threshold to said autofluorescence image. In one embodiment, this threshold may comprise a particle-specific threshold based on integrated intensity. This threshold may be such that substantially all of the active ingredients of interest will autofluoresce and no (or a small percentage) of non-active ingredients will autofluoresce. This may enable visualization, via an autofluorescence image, of only active ingredients of interest. A system and method for thresholding is described more fully in U.S. Patent Application Publication No. US2010/0179770, filed on Jan. 8, 2010, entitled “Automation of Ingredient-Specific Particle Sizing Employing Raman Chemical Imaging,” which is hereby incorporated by reference in its entirety.

In step 173, each region of interest may be targeted to thereby generate at least one Raman chemical image representative of each region of interest. The present disclosure contemplates that these regions of interest may be targeted sequentially, simultaneously, and combinations thereof.

A Raman chemical image may be analyzed in step 174 to thereby determine at least one geometric property of said particle. In one embodiment, this geometric property may comprise a property selected from the group consisting of: an area, a perimeter, a feret diameter, a maximum chord length, a shape factor, an aspect ratio, and combinations thereof. In another embodiment, this geometric property of said particle may be characteristic of particle size distribution.

In one embodiment, analyzing said Raman chemical image may further comprise applying at least one chemometric technique. This chemometic technique may be selected from the group consisting of: principle component analysis, linear discriminant analysis, partial least squares discriminant analysis, maximum noise fraction, blind source separation, band target entropy minimization, cosine correlation analysis, classical least squares, cluster size insensitive fuzzy-c mean, directed agglomeration clustering, direct classical least squares, fuzzy-c mean, fast non negative least squares, independent component analysis, iterative target transformation factor analysis, k-means, key-set factor analysis, multivariate curve resolution alternating least squares, multilayer feed forward artificial neural network, multilayer perception-artificial neural network, positive matrix factorization, self modeling curve resolution, support vector machine, window evolving factor analysis, and orthogonal projection analysis.

### Example

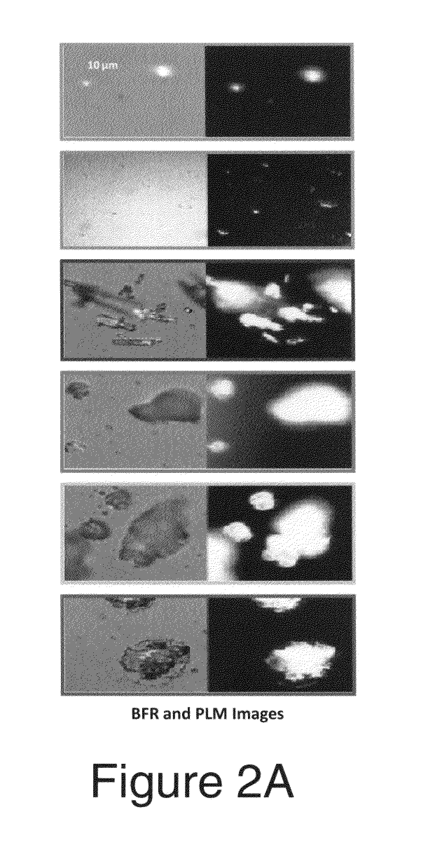

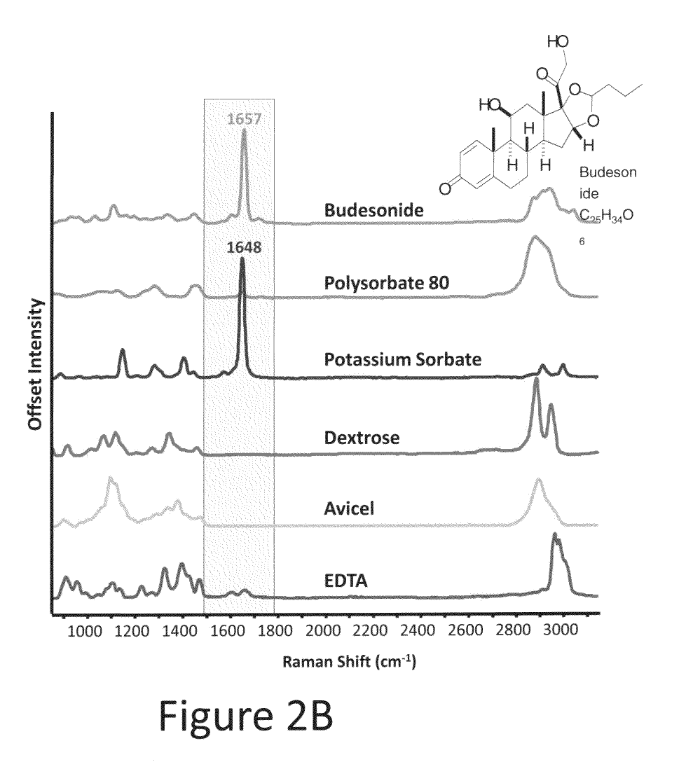

FIGS. 2A-8E are illustrative of the detection capabilities of a system and method of the present disclosure. All data was collected using a FALCON II™ Wide-Field Raman Chemical Imaging System (ChemImage Corporation, Pittsburgh, Pa.) with 532 nm laser excitation (FIG. 1). Raman dispersive spectra were collected on the budesonide API as well as the five excipient components of Rhinocort Aqua®: polysorbate 80; potassium sorbate; dextrose; microcrystalline cellulose and EDTA. Based upon the Raman spectroscopy of the pure ingredients, a spectral region was identified to include a characteristic C=C feature at 1656 cm⁻¹ which differentiated the budesonide API from the excipients as illustrated in FIGS. 2A and 2B. Brightfield reflectance (BFR) and Polarized Light Microscopy (PLM) images are illustrated in FIG. 2A. Raman dispersive spectra of Rhinocort Aqua® pure components are illustrated in FIG. 2B, wherein the spectral range for RCI is highlighted in yellow. The experimental parameters for the Raman dispersive spectroscopy and RCI are listed in Table 1.

TABLE 1
Measurement parameters for Raman dispersive spectroscopy and
Raman Chemical Imaging

| | Raman Dispersive | Raman Chemical |
|---|---|---|
| Parameter | Spectroscopy | Imaging |
| Microscope Objective | 20x (NA = 0.46) | 50x (NA = 0.80) |
| Laser wavelength | 532 nm | 532 nm |
| Laser power density (at the | 3.2 μW/μm² | 24 μW/μm² |
| sample) | | |
| Spectral Range | 350-3500 cm⁻¹ | 1620-1680 by 5 cm⁻¹ |
| Integration Time | 0.5-5.0 sec/sample | 5 sec/frame |
| Averages | 5 | 1 |
| Binning | N/A | 8 × 8 |
| Photobleach Time | 20 sec/spectrum | 20 sec/field of view |

A formulated sample was prepared by shaking, priming and spraying in an upright position onto an inverted, aluminum-coated glass microscope slide positioned approximately 15 cm above the spray nozzle. The microscope slide was then immediately turned upright and the nasal suspension droplets were allowed to dry.

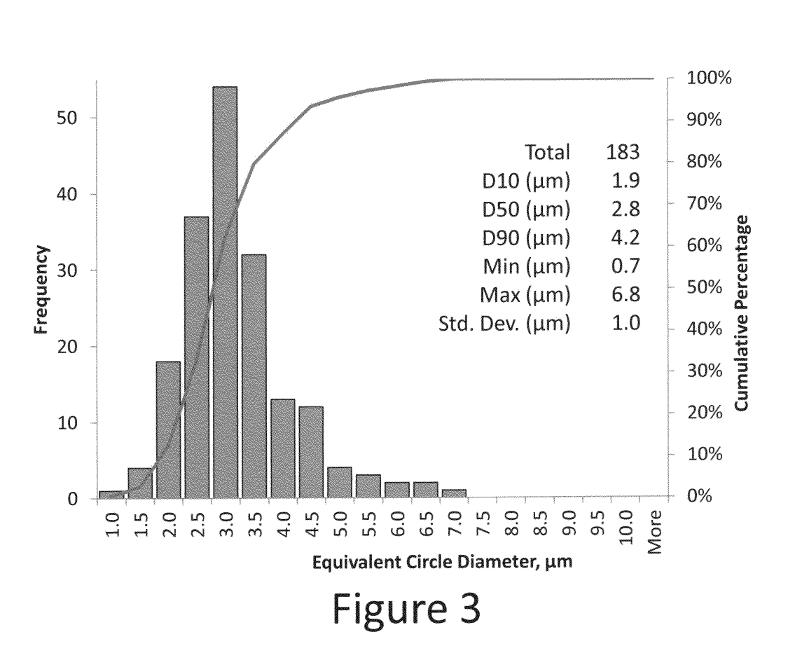

Brightfield reflectance, cross-polarization, autofluorescence and Raman Chemical Images were collected in an automated mode over 18×18 Fields of View (FOV) comprising a total sampling area of 0.54 mm². The autofluorescence images were collected RGB video images of the integrated visible fluorescence from 365 nm excitation. Raman Chemical Images were collected over an API-specific spectral region identified from the Raman dispersive spectra (1620-1680 cm⁻¹) at a 5 cm⁻¹ interval. Automated software processing was then used to detect, identify and measure the particle size distribution (PSD) associated with the API where the particle intensity map employed a localized thresholding process. The API PSD of a single Rhinocrt® droplet based upon equivalent circle diameter is shown in FIG. 3. Specifically, FIG. 3 illustrates the equivalent circle diameter particle size distribution for budesonide in Rhinocort Aqua®.

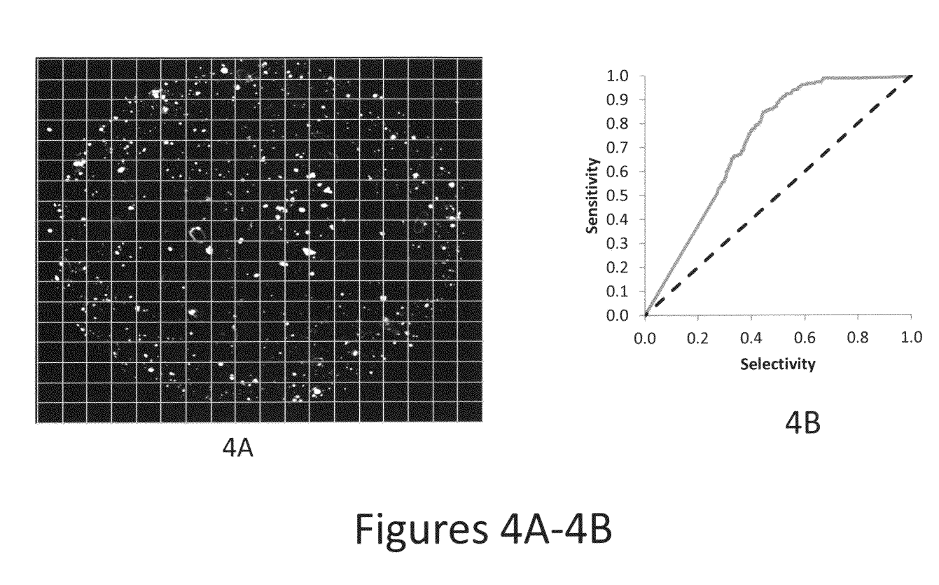

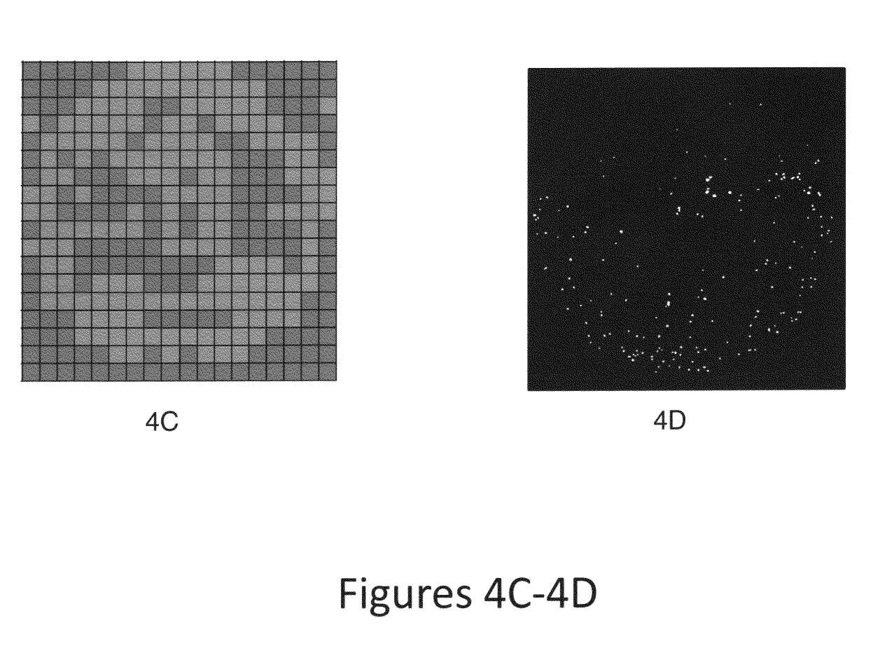

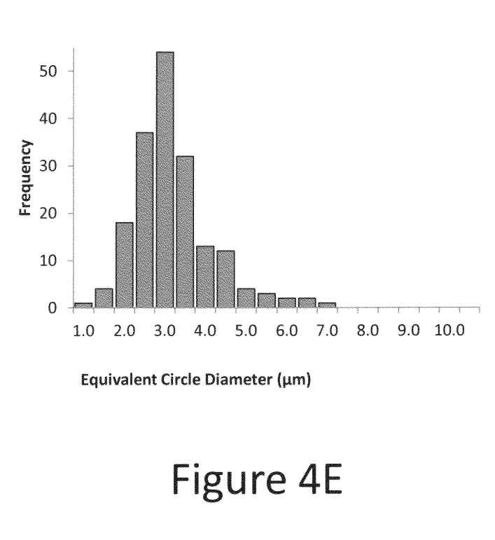

An ISPS process incorporating a rapid screening modality followed by wide-field Raman Chemical Imaging is illustrated in FIGS. 4A-4E. In order to efficiently utilize the wide-field data collection of RCI, a sampling space is divided into a grid based upon the sampling area observed by the RCI camera. This is illustrated by FIG. 4A. FIG. 4B illustrates the application of a threshold to screening an image based on optimal API sensitivity. FIG. 4C illustrates the identification of optimal ROIs for wide-field RCI of API particles. If the rapid screening modality registers a detection event inside of the grid, an RCI measurement will be performed for confirmation of API particles. FIG. 4D illustrates wide-field RCI over an optimal ROI. FIG. 4E illustrates the calculation of geometric properties and the generation of statistical information.

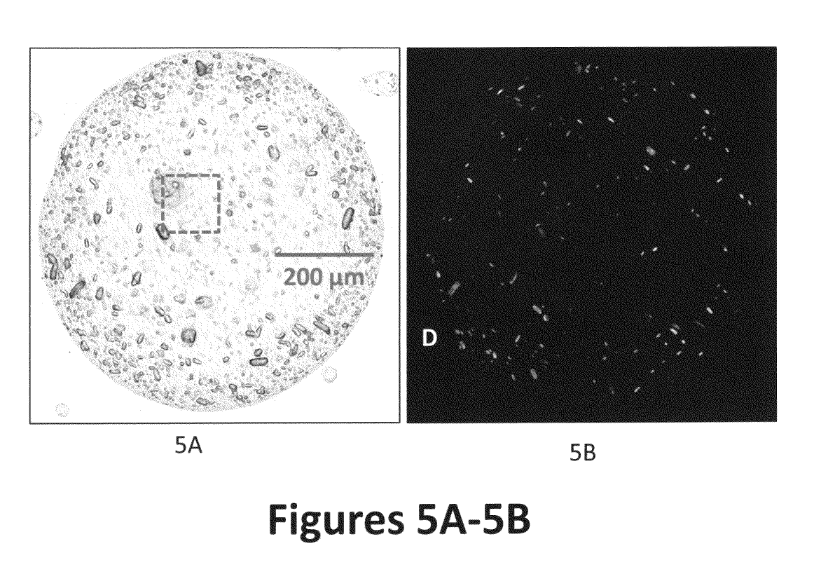

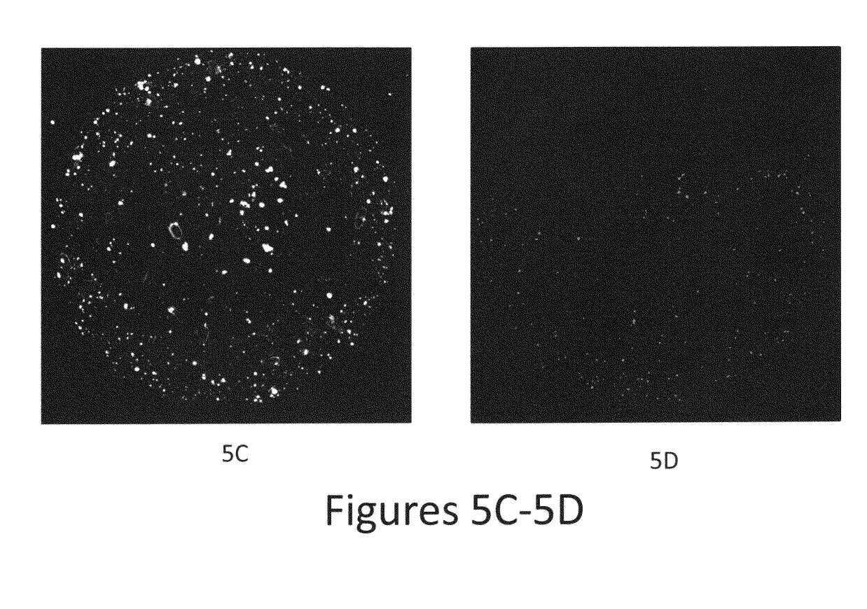

To compare the various rapid screening modalities, the API particle maps based upon the RCI data were treated as ground truth for particle location and identification. The various auxiliary modalities as well as the RCI ground truth particle map are illustrated in FIGS. 5A-5D. FIG. 5A illustrates brightfield reflectance, FIG. 5B illustrates cross-polarization, FIG. 5C illustrates autofluorescence, FIG. 5D illustrates a Raman API particle map images of Rhinocort Aqua®.

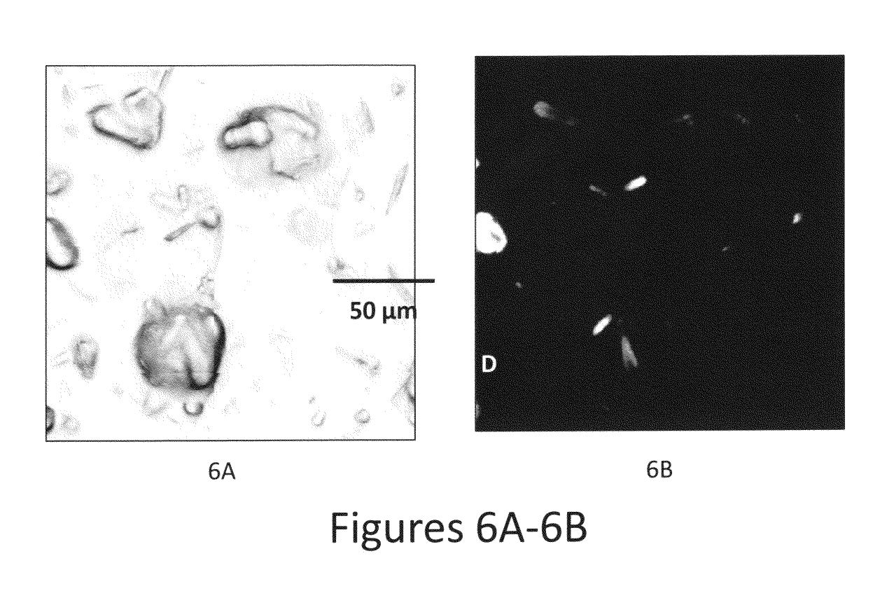

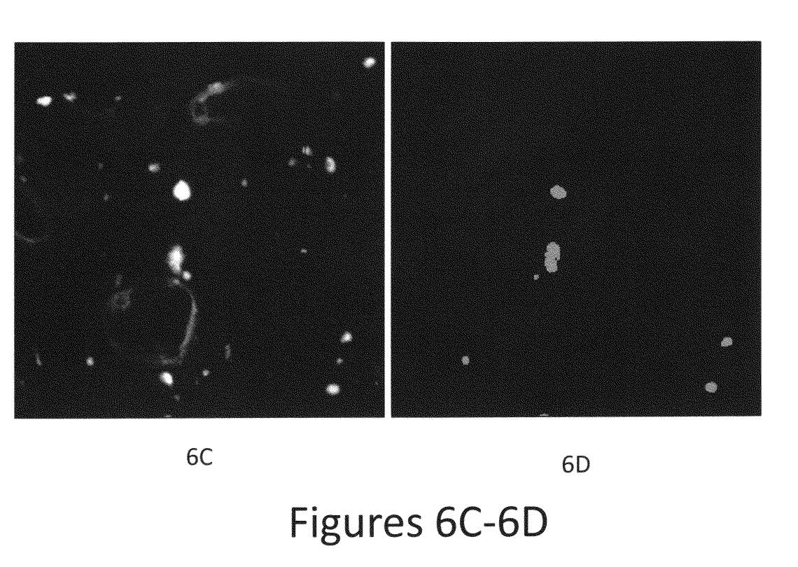

FIGS. 6A-6D illustrate a magnified ROI from the red dashed box in FIG. 5. FIG. 6A illustrates brightfield reflectance, FIG. 6B illustrates cross-polarization, FIG. 6C illustrates autofluorescence, and FIG. 6D illustrates a Raman API particle map images of Rhinocort Aqua®.

It is challenging for a human observer to identify similar API particles in the brightfield image due to contrast based upon refractive index differences, and the cross-polarization image indicates that the API particles are not significantly birefringent. Cross-polarization may miss particles, thereby not providing for sizing of every particle present in the sample. Qualitatively, the autofluorescence image exhibits API particle detections in similar locations as the ground truth as compared to the brightfield and cross-polarization images.

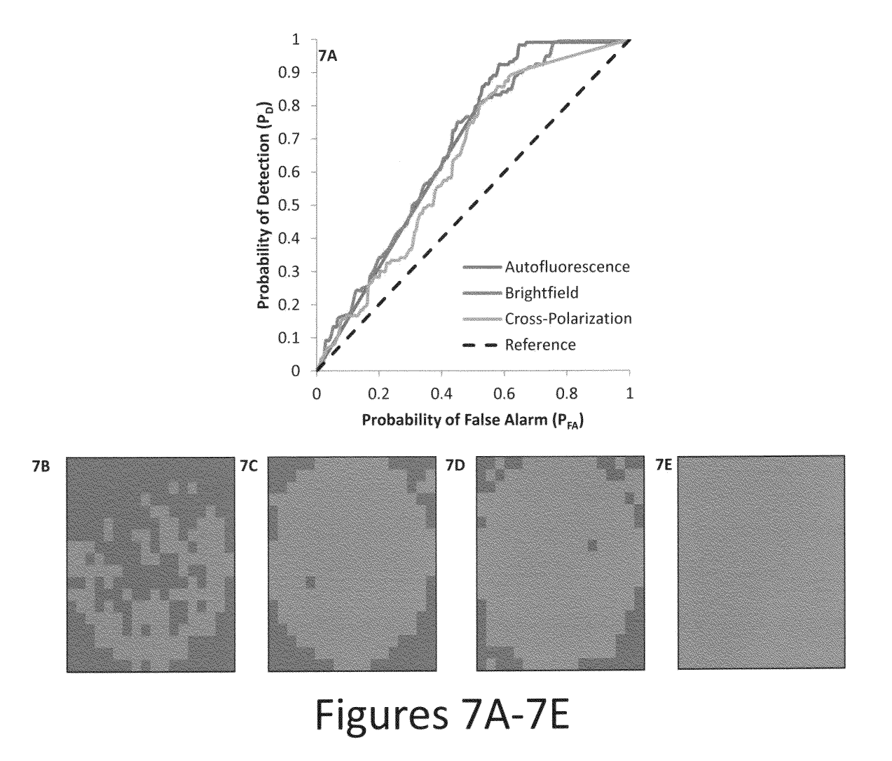

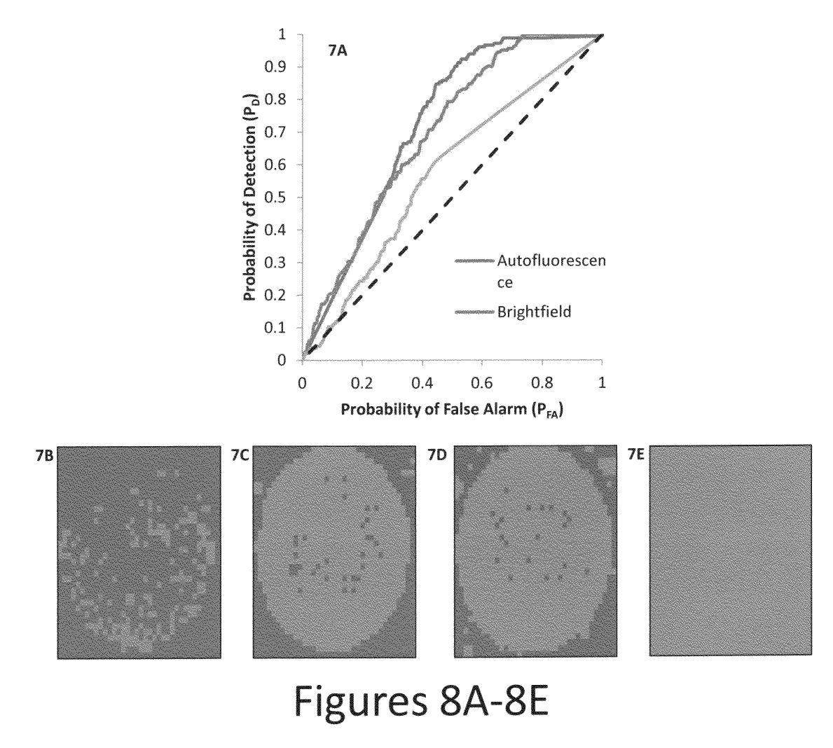

A quantitative assessment of the rapid screening modalities was performed by analyzing Receiver Operator Characteristic (ROC) curves for each measurement. A ROC curve is a graphical assessment of detection sensitivity (or Probability of Detection, P_{D}) versus selectivity (or Probability of False Alarm, P_{FA}). An ideal detector possesses an Area Under the ROC (AUROC) curve equal to unity. FIGS. 7A-7E and FIGS. 8A-8E illustrate ROC curves for identifying API particle containing FOVs within the defined sampling grids: 18×18 FOVs and 36×36 FOVs. In FIGS. 7A-7E, ROC curves for the identification of a region of interest containing an API particle for 18×18 fields of view is illustrated in FIG. 7A. FIG. 7B represents a ground truth image; FIG. 7C illustrates an autofluorescence image; FIG. 7D illustrates a brightfield reflectance image; and FIG. 7E represents a cross-polarization image.

FIG. 8A represents ROC curves for the identification of a region of interest containing an API particle for 36×36 fields of view. FIG. 8B illustrates a ground truth image; FIG. 8C illustrates detection images at P_{D}=99% for autofluorescence; FIG. 8D illustrates detection images at P_{D}=99% for brightfield reflectance; and FIG. 8E illustrates detection images at P_{D}=99% for cross-polarization.

The 18×18 FOVs represents the normal mode of operation while the 36×36 FOVs represents a low magnification screening for a higher magnification confirmation. In this example, the screening occurs with a 50× microscope objective and the confirmation occurs with a 100× objective. In both instances, the autofluorescence modalilty exhibited the highest AUROC, and cross-polarization exhibited the lowest AUROC.

All auxiliary modalities possess a large P_{FA} (>60%), but brightfield reflectance and autofluorescence may be employed to decrease the total number of wide-field RCI ROIs necessary to sample the API particle population (P_{D}=99%) within the sampling area. The experimental time savings based upon employing the rapid screening process for budesonide in Rhinocort® is illustrated in Table 2 as well as the AUROC for each auxiliary screening modality.

TABLE 2
AUROC and experimental time savings for each auxiliary modality
for identifying ROIs with API particles

| | 18 × 18 | | 36 × 36 | |
|---|---|---|---|---|
| | Fields of View | | Fields of View | |
| | | Time | | Time |
| | | Savings | | Savings |
| Modality | AUROC | (P_{D} = 0.99) | AUROC | (P_{D} = 0.99) |
| Autofluorescence | 0.675 | 27% | 0.723 | 40% |
| Brightfield | 0.670 | 18% | 0.699 | 30% |
| Cross-Polarization | 0.636 | 0% | 0.574 | 0% |

Autofluorescence or brightfield reflectance imaging shows promise as a method for rapid screening for API particle wide-field FOVs before chemical confirmation using wide-field Raman Chemical Imaging. This approach can lessen the required experimental time for ISPS data acquisition while maintaining a high degree of sampling efficiency. A quantitative assessment of the three auxiliary modalities based on ROC curves showed the autofluorescence method to be superior for the identification of API containing ROIs in Rhinocort Aqua®.

Although the disclosure is described using illustrative embodiments provided herein, it should be understood that the principles of the disclosure are not limited thereto and may include modification thereof and permutations thereof.

What is claimed is:

1. A method comprising:
generating at least one autofluorescence image representative of a sample, wherein said sample comprises at least one particle associated with an active ingredient of interest;
analyzing said autofluorescence image to thereby identify a plurality of regions of interest, wherein each said region of interest exhibits autofluorescence characteristic of at least one active ingredient of interest;
targeting each said region of interest to thereby generate at least one Raman chemical image representative of each region of interest; and
analyzing said Raman chemical image to thereby determine at least one geometric property of said particle.

2. The method of claim 1 wherein said geometric property is selected from the group consisting of: an area, a perimeter, a feret diameter, a maximum chord length, a shape factor, an aspect ratio, and combinations thereof.

3. The method of claim 1 wherein said geometric property of said particle is characteristic of particle size distribution.

4. The method of claim 1 wherein said analyzing further comprises applying at least one threshold to said autofluorescence image.

5. The method of claim 4 wherein said threshold comprises a particle-specific threshold.

6. The method of claim 1 wherein analyzing said Raman chemical image further comprises applying at least one chemometric technique.

7. The method of claim 6 wherein said chemometric technique is selected from the group consisting of: principle component analysis, linear discriminant analysis, partial least squares discriminant analysis, maximum noise fraction, blind source separation, band target entropy minimization, cosine correlation analysis, classical least squares, cluster size insensitive fuzzy-c mean, directed agglomeration clustering, direct classical least squares, fuzzy-c mean, fast non negative least squares, independent component analysis, iterative target transformation factor analysis, k-means, key-set factor analysis, multivariate curve resolution alternating least squares, multilayer feed forward artificial neural network, multilayer perception-artificial neural network, positive matrix factorization, self modeling curve resolution, support vector machine, window evolving factor analysis, and orthogonal projection analysis.

8. The method of claim 1 wherein said method is automated via software.

9. The method of claim 1 wherein each said region of interest is targeted sequentially.

10. The method of claim 1 wherein each said region of interest is targeted simultaneously.

11. The method of claim 1 wherein said sample comprises at least two particles, wherein a first particle is associated with a first active ingredient of interest and a second particle is associated with a second active ingredient of interest.

12. The method of claim 11 wherein analyzing said Raman chemical image further comprises determining at least one geometric property of said first particle and at least one geometric property of said second particle.

13. A system comprising:
a first illumination source configured so as to illuminate at least a portion of a sample to thereby generate a first plurality of interacted photons, wherein said sample comprises at least one particle associated with an active ingredient of interest;
a first detector configured so as to detect said first plurality of interacted photons and generate at least one autofluorescence image representative of said sample;
a means for analyzing said autofluorescence image to thereby identify at least one region of interest of said sample, wherein each said region of interest exhibits autofluorescence characteristic of at least one active ingredient of interest;
a second illumination source configured to illuminate at least one said region of interest to thereby generate a second plurality of interacted photons;
a filter configured so as to sequentially filter said second plurality of interacted photons into a plurality of predetermined wavelength bands;
a second detector configured so as to detect said second plurality of interacted photons and generate at least one Raman chemical image representative of said region of interest; and
a means for analyzing said Raman chemical image to thereby determine at least one geometric property representative of said particle.

14. The system of claim 13 wherein said first detector comprises a visible RGB camera.

15. The system of claim 14 wherein said second detector comprises a focal plane array detector.

16. The system of claim 15 wherein said second detector comprises at least one of: a CCD, an ICCD, a CMOS detector, and combinations thereof.

17. The system of claim 13 wherein said filter comprises a tunable filter selected from the group consisting of: a liquid crystal tunable filter, a multi-conjugate liquid crystal tunable filter, an acousto-optical tunable filter, a Lyot liquid crystal tunable filter, an Evans split-element liquid crystal tunable filter, a Solc liquid crystal tunable filter, a ferroelectric liquid.

18. The system of claim 13 wherein said first illumination source comprises a mercury arc lamp.

19. The system of claim 13 wherein said second illuminations source comprises a monochromatic light source.

20. A storage medium containing machine readable program code, which, when executed by a processor, causes said processor to perform the following:
generate at least one autofluorescence image representative of a sample, wherein said sample comprises at least one particle associated with an active ingredient of interest;
analyze said autofluorescence image to thereby identify a plurality of regions of interest, wherein each said region of interest exhibits autofluorescence characteristic of at least one active ingredient of interest;
target each said region of interest to thereby generate at least one Raman chemical image representative of each region of interest; and
analyze said Raman chemical image to thereby determine at least one geometric property of said particle.

21. The storage medium of claim 20, which when executed by a processor, further causes said processor to apply a particle-specific threshold to said autofluorescence image.

22. The storage medium of claim 20, which when executed by a processor, further causes said processor to apply at least one chemometric technique to said Raman chemical image.
